(19) United States
(12) Patent Application Publication
(10) Pub. No.: US 2026/0025748 A1
(43) Pub. Date: Jan. 22, 2026

(54) SYSTEM AND METHOD OF NETWORK SWITCHING

(71) Applicant: JIO PLATFORMS LIMITED, Ahmedabad, Gujarat (IN)

(72) Inventors: Adityakar JHA; Aayush BHATNAGAR, Navi Mumbai, Maharashtra (IN); Akash Mukesh AMBANI, Mumbai, Maharashtra (IN); Hardik Navinbhai BAVISHI, Navi Mumbai, Maharashtra (IN); Veerat Sunil KULKARNI, Dist-Thane, Maharashtra (IN)

(73) Assignee: JIO PLATFORMS LIMITED, Ahmedabad, Gujarat (IN)

(21) Appl. No.: 18/993,052

(22) PCT Filed: Mar. 13, 2024
(86) PCT No.: PCT/IN2024/050257

§ 371 Date: Jan. 10, 2025

(30) Foreign Application Priority Data
Mar. 29, 2023 (IN) 202321023228

(51) Int. Cl. H04W 48/18; H04W 8/08

(52) U.S. Cl. CPC H04W 48/18; H04W 8/08

(57) ABSTRACT

The present disclosure relates to a system (100) and a method for switching user equipment(s) (UEs) between communication networks (4G, 5G, and 6G). The method includes detecting an outage (service failure or interruption in service) in a network based on a reference signal received power (RSRP), a reference signal received quality (RSRQ), and a signal-to-interference-plus-noise ratio (SINR) and switching the UE from a first network to a second network. On detecting the outage, a mobility management entity (MME) queries a home subscriber server (HSS) for the UE usage type. If the user is 4G-only, the MME selects 4G network and if the user is migrated to 4G/5G combination core, then the MME selects the 5G network. A circle-wise global flag in the HSS return “4G” for the MME query regarding the UE usage type, so the MME selects the 4G core and the user will move to the 4G network.

### RESERVATION OF RIGHTS

A portion of the disclosure of this patent document contains material, which is subject to intellectual property rights such as, but are not limited to, copyright, design, trademark, integrated circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure relates generally to the field of telecommunications network. In particular, the present disclosure relates to switchover by a user equipment (UE) in a wireless communication system.

### DEFINITION

As used in the present disclosure, the following terms are generally intended to have the meaning as set forth below, except to the extent that the context in which they are used to indicate otherwise.

The term “network entity” used hereinafter in the specification refers to an entity that serves a cellular network for providing voice services (i.e., calls) and data services to a user equipment. The network entity may include, but not be limited to, a base station controller, a base transceiver station, a cell site, a NodeB, an eNodeB, a gNodeB, a radio network controller, and any such entity obvious to a person skilled in the art.

The term “wireless device” or “user equipment (UE)” used hereinafter in the specification refers to a computing device that is latched to the network entity to receive voice and data services. The wireless device may refer to any one of various cellular telephones, personal data assistants (PDA's), palm-top computers, laptop computers with wireless modems, wireless electronic mail receivers, multimedia Internet enabled cellular telephones, and similar personal electronic devices. A wireless device may include a programmable processor and memory. In a preferred embodiment, the wireless device is a cellular handheld device (e.g., a wireless device), which can communicate via a cellular telephone communications network. A person of ordinary skill in the art will appreciate that the terms “wireless device” and “user equipment (UE)” may be used interchangeably throughout the disclosure.

The term “UE-Usage-Type (UUT)” used hereinafter in the specification indicates the usage characteristics of the UE that enables the selection of a specific dedicated core network (DCN) or data network. Different data networks are deployed by network service providers to serve specific subsets of subscribers. The DCN supports multiple RAN types and includes regular core network nodes, such as the MME (Mobility Management Entity), S-GW (Serving Gateway) and P-GW (PDN Gateway). UE-Usage-Type is stored in a HSS (Home Subscriber Server) within the subscription information of the UE. Each UE can have no more than one UE-Usage-Type. This functionality of selecting P-GW based on UUT is used to latch the subscribers to different data networks by assigning an appropriate UUT value.

The term “Attribute Value Pair (AVP)” used hereinafter in the specification indicates a format used to represent information in various domains. The Attribute Value Pair operates on a concept of key-value pairs. The attribute serves as the key, while the value corresponds to the associated data. This structure enables efficient storage, retrieval, and processing of information. An UUT AVP includes a value corresponding to a UUT. For example, if UUT AVP has a value corresponds to 5G, and the user equipment may be connected to the 5G network.

The term “Home Subscriber Server (HSS)” used hereinafter in the specification indicates a function that is configured to manage subscriber information that contains subscriber information, device profile, and state information. HSS is configured to cater various tasks such as authentication, authorization, and mobility management functions for various networks. The HSS supports authentication and security procedures for network access by providing credentials and keys towards network entities (MME). The HSS is a central database that contains all relevant details about a subscriber's information and user authentication. HSS also provides information for calls and IP session set up. This server makes it easier for service providers to manage the information of their subscribers in real time.

The term “Mobility Management Entity (MME)” used hereinafter in the specification is responsible for tasks such as user registration, session management, handover coordination, security, and location tracking. The MME is responsible for handling signals between active UEs and a network. It is also responsible for signalling between eNodeB and the core network. For continuous functionality, MME also keeps track of the UE's location within the network. MME authenticates UEs by communicating with the HSS.

The term “circle-wise global flag” used hereinafter in the specification indicates a variable that signals a particular condition or state of circle level. The circle-wise global flag variable is accessible and modifiable from any part of a program.

The term “outage” used hereinafter in the specification indicates to a temporary disruption or interruption in service. This can occur due to various reasons such as natural disasters, equipment failure, or maintenance. During the outage, a subscriber is unable to use the services such as data services, calling facilities etc.

These definitions are in addition to those expressed in the art.

### BACKGROUND OF INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Network experience may vary for different locations. The network availability may be down at various levels like at circle level or super core levels, which may affect the subscriber-registered services. The network availability may sometimes be down due to outages. The outages may be at the circle level like access and mobility management function (AMF), session management function (SMF), or user plane function (UPF) may be affected. The other outage may be at super core level like policy control function (PCF), or other network functions or data center may be affected. In another case, outage may be at both at circle level and super core level.

In conventional systems and methods, few subscribers may move to fifth generation (5G) services and others may still be on 4G. 5G subscribers, in absence of the 5G network must get at least 4G services. Moreover, as soon the 5G network is available, the 5G services must restore back. This transition between the networks is not spontaneous, smooth, and transparent to users in the conventional systems and methods.

Therefore, there is a well-felt need for an improved and efficient mechanism for switching of users between networks that addresses at least the above-mentioned issues and shortcomings.

### OBJECTS OF THE INVENTION

An object of the present disclosure is to provide an efficient approach towards switchover of user equipment(s) between networks.

An object of the present disclosure is to switch users seamlessly and gradually between networks (for example, 4G, 5G, 6G) if there is an issue in the serving network, thereby avoiding spikes in traffic.

An object of the present disclosure is to ensure that subscriber profiles are not duplicated due of switchover of the user equipment(s).

An object of the present disclosure is to ensure that subscriber profiles are not duplicated due of switchover of the user equipment(s).

### SUMMARY

The present disclosure discloses a system for switching at least one user equipment (UE) connected with a first network to a second network on detection of an outage in the first network. The system includes a home subscriber server (HSS) and a mobility management entity (MME). The HSS is configured to generate a UE-usage-type (UUT) attribute value pair (AVP) value corresponding to the at least one UE. The mobility management entity (MME) is configured to receive the generated UUT AVP value from the HSS and is further configured to determine a type of the at least one UE based on the received UUT AVP value and switch the UE to the second network based on the determined type of the at least one UE.

In an embodiment, the determined type is a fourth-generation (4G) UE, or a fifth-generation (5G) UE, or a sixth-generation (6G) UE.

In an embodiment, the system is configured to detect the outage of the first network based on a number of parameters including a reference signal received power (RSRP), a reference signal received quality (RSRQ), and a signal-to-interference-plus-noise ratio (SINR).

In an embodiment, the MME is further configured to switch the at least one UE to the first network from the second network upon restoration of the first network.

In an embodiment, the UUT AVP value further includes an updated location value of the at least one UE.

In an embodiment, the outage comprises at least one of a hardware outage and software outage of at least one serving cell in the first network.

In an embodiment, the system is configured to detect the outage on edge location level, a circle level, and a super core level.

In an embodiment, the HSS is configured to enable a circle-wise global flag on detection of the outage in a circle level node(s) and sets the UUT AVP value as the second network for the at least one UE latched to the circle level node(s).

In an embodiment, the circle level node(s) includes a public land mobile network (PLMN).

In an embodiment, the HSS is configured to disable the circle-wise global flag on resolving the outage in the circle level node(s), thereby enabling transfer of the at least one UE to the circle level node(s).

In an embodiment, the HSS is configured to enable a global flag on detection of the outage in a super core level node(s) and sets the UUT AVP value as the second network for the at least one UE latched to the super core level node(s).

In an embodiment, the super core level node(s) includes at least one data center.

In an embodiment, the HSS is configured to disable the global flag on resolving the outage in the super core level node(s), thereby enabling transfer of the at least one UE to the super core level node(s).

In an embodiment, the MME is configured to map the UUT AVP value with a set of predefined UUT values stored in a table corresponding to a number of gateway planes connected with the first network and the second network.

In an embodiment, the MME is configured to select at least one of a gateway-control plane (GW-C), a fully qualified domain name (FQDN), and a gateway-user plane (GW-U) connected with the second network if the UUT AVP value is corresponds to NO and mapped with at least one UUT values from the set of predefined UUT values stored in the table.

In an embodiment, the MME is configured to select at least one of a gateway-control plane (GW-C) and a session management function (SMF) connected with the first network if the UUT AVP value is corresponds to 5G and mapped with at least one UUT values from the set of UUT values stored in the table.

In an embodiment, the MME is configured to select a session management function (SMF) or a user plane function (UPF) if the determined type of the at least one UE is migrated to the 4G/5G.

In an embodiment, the MME is further configured to switch the at least one UE to the first network from the second network upon restoration of the first network.

The present disclosure discloses a method of switching at least one user equipment (UE) connected with a first network to a second network on detection of an outage in the first network. The method includes generating a UE-usage-type (UUT) attribute value pair (AVP) value corresponding to the at least one UE. The method includes determining a type of the at least one UE based on the received UUT AVP value. The method includes switching the at least one UE to the second network based on the determined type of the at least one UE.

In an embodiment, the at least one UE is switched from the second network to the first network on detection an outage in the first network.

In an embodiment, the method further includes switching the at least one UE to the first network from the second network upon restoration of the first network.

In an embodiment, the method further includes detecting the outage of the first network based on a number of parameters including a reference signal received power (RSRP), a reference signal received quality (RSRQ), and a signal-to-interference-plus-noise ratio (SINR).

In an embodiment, the method further includes detecting the outage on edge location level, a circle level, and a super core level.

In an embodiment, the method further includes enabling a circle-wise global flag on detection of the outage in a circle level node(s) and sets the UUT AVP value as the second network for the at least one UE latched to the circle level node(s).

In an embodiment, the method further includes disabling the circle-wise global flag on resolving the outage in the circle level node(s), thereby enabling transfer of the at least one UE to the circle level node(s).

In an embodiment, the method further includes to enabling a global flag on detection of the outage in a super core level node(s) and setting the UUT AVP value as the second network for the at least one UE latched to the super core level node(s).

In an embodiment, the method further includes disabling the global flag on resolving the outage in the super core level node(s), thereby enabling transfer of the at least one UE to the super core level node(s).

In an embodiment, the method further includes mapping the UUT AVP value with a set of UUT values stored in a table corresponding to a number of gateway planes connected with the first network and the second network.

In an embodiment, the method further includes selecting at least one of a gateway-control plane (GW-C), a fully qualified domain name (FQDN), and a gateway-user plane (GW-U) connected with the second network if the UUT AVP value is corresponds to NO and mapped with at least one UUT values from the set of predefined UUT values stored in the table.

In an embodiment, the method further includes selecting at least one of a gateway-control plane (GW-C) and a session management function (SMF) connected with the first network if the UUT AVP value is corresponds to 5G and mapped with at least one UUT values from the set of predefined UUT values stored in the table.

The present disclosure discloses a user equipment (UE) configured to switch from a first network to a second network on detection of an outage in the first network. The user equipment includes a processor, and a computer readable storage medium storing programming for execution by the processor. The programming including instructions to generate a UE-usage-type (UUT) attribute value pair (AVP) value corresponding to the UE. The programming including instructions to generate determine a type of the UE based on the received UUT AVP value. The programming including instructions to generate switch the UE from the first network to the second network based on the determined type of the UE.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary architecture of a system for performing switchover between a first network and a second network, in accordance with an embodiment of the present disclosure.

FIG. 2 illustrates an exemplary representation of a connection between a user equipment (UE) and a network entity, in accordance with an embodiment of the present disclosure.

FIGS. 3A-3B illustrate exemplary signal flow diagrams for implementing a switchover of the UE between networks (a first network and a second network), in accordance with embodiments of the present disclosure.

FIG. 4 illustrates an exemplary representation of communication between a mobility management entity (MME), a home subscriber server (HSS), and network entry points, in accordance with an embodiment of the present disclosure.

FIG. 5 illustrates an exemplary architecture of a system for implementing a circle level service impact (outage) for a Policy Control Function (PCF), a session management function (SMF), and a user plane function (UPF), in accordance with an embodiment of the present disclosure.

FIGS. 6A-6B illustrate an exemplary sequence flow diagrams of a method for implementing a circle level service impact for PCF, SMF, and UPF network functions, in accordance with embodiments of the present disclosure.

FIG. 7 illustrates an exemplary architecture of a system for implementing a super core level service impact, in accordance with an embodiment of the present disclosure.

FIGS. 8A-B illustrate exemplary sequence flow diagrams of a method for implementing a super core level service impact, in accordance with embodiments of the present disclosure.

FIG. 9 illustrates an exemplary architecture of a system for implementing a circle level service impact as well as a super core level service impact, in accordance with an embodiment of the present disclosure.

FIGS. 10A-10B illustrate exemplary sequence flow diagrams of a method for implementing a circle level service impact as well as a super core level service impact, in accordance with embodiments of the present disclosure.

FIG. 11 illustrates an exemplary computer system in which or with which embodiments of the present disclosure may be implemented.

The foregoing shall be more apparent from the following more detailed description of the disclosure.

### LIST OF REFERENCE NUMERALS

100—System
100-1—First Network
100-2—Second Network
102, 202—User Equipment (UE)
104—First Network Entity
106—Second Network Entity
108—Access and Mobility Management Function (AMF)
110—Session Management Function (SMF)
112—User Plane Function (UPF)
114—Policy Control Function (PCF)
116, 134—Home Subscriber Server (HSS)
118—5G network functions (NFs)
120—Mobility Management Entity (MME)
122—Serving Gateway (SGW)
124—Packet Network Data Gateway (PGW)
126—Policy And Charging Rules Function (PCRF)
128—Diameter Routing Agent (DRA)/Subscriber Location Function (SLF)
130—Evolved Packet Core (EPC) Nodes
132-1, 132-2—Data Network
204—Network Entity
1110—External Storage Device
1120—Bus
1130—Main Memory
1140—Read Only Memory
1150—Mass Storage Device
1160—Communication Port
1170—Processor

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a

process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology are also seen. The development, in this respect, has been incremental in the order of second generation (2G), third generation (3G), fourth generation (4G), fifth generation (5G), and now sixth generation (6G), and more such generations are expected to continue in the forthcoming time.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

The present disclosure relates to systems and methods for network switching of a user equipment. As an example, fourth generation (4G) and 5G networks exist in tandem. In an aspect, the system is applicable for sixth generation (6G) network also. The 5G core is a combo-core which serves migrated customers from the 4G network when they are in 5G or 4G coverage alike. The present disclosure provides a spontaneous, smooth, and transparent approach towards switching over of the user equipment between different communication networks (4G, 5G and 6G). The changeover happens without touching the provisioning architecture of network entities or nodes. The subscriber profiles are not duplicated.

In an embodiment, a user equipment (UE) usage type (UUT), stored in a home subscriber server (HSS), is be used by a serving network, for example, mobility management entity (MME) to select a core network that should serve the UE. The HSS provides the UUT value in subscription information of the UE to the MME. Based on UUT to network mapping, the MME selects one of the multiple the core networks deployed. As an example, but not limitation, Table 1 shows the UUT to network mapping that is referred to by the MME while selectin the core network for the UE.

TABLE 1

| UUT from HSS | Gateway (GW) selection |
|---|---|
| 5G | 1. One of the GWs mapped to UUT = 5G is selected |
| | (e.g., combo SMF/GW-C). |
| | 2. If no GW with UUT = 5G is mapped, one of the GWs |
| | with UUT = NO is selected (e.g., 4G Only GW). |
| | 3. If no GW is mapped to UUT = 5G or UUT = NO, |
| | then GW selection fails. |
| No UUT (4G | 1. One of the GWs mapped to UUT = NO is selected |
| Only | (e.g., 4G Only GW). |
| Subscriber) | 2. If no GW is mapped to UUT = NO, then GW |
| | selection fails. GW with any other mapped UUT |
| | value will not be selected. |
| UUT Value | 1. One of the GWs mapped to UUT = NO is selected |
| with no | (e.g., 4G Only GW). |
| mapping | 2. If no GW is defined and mapped to UUT = NO, |
| in MME | then GW selection fails. GW with any UUT value |
| | mapped will not be selected. |

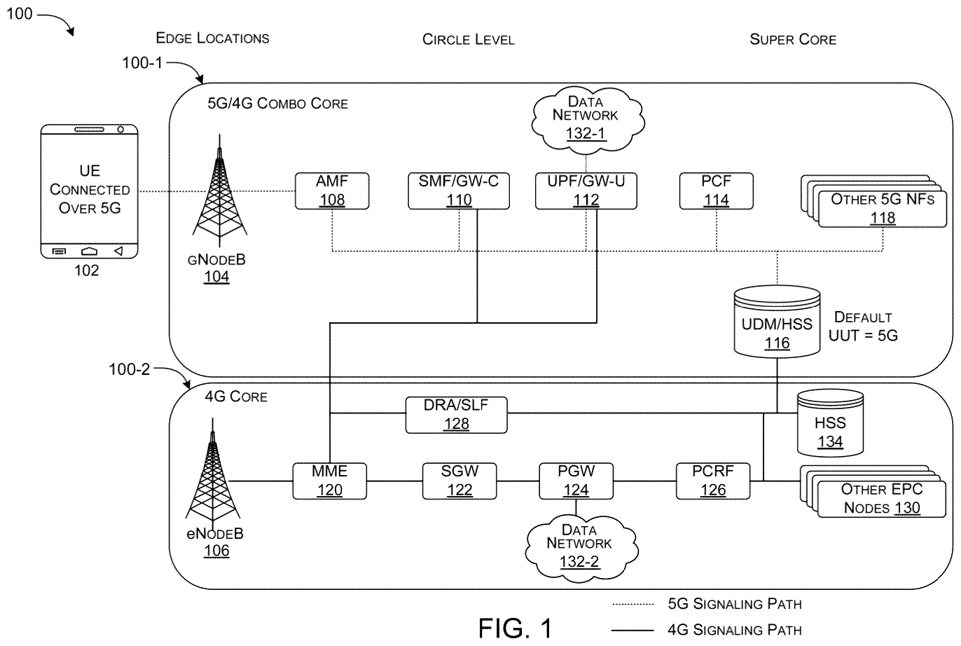

The various embodiments throughout the disclosure will be explained in more detail with reference to FIG. 1-FIG. 11.

FIG. 1 illustrates an exemplary architecture of a system 100 for switching at least one user equipment (UE) 102 from a first network (100-1) to a second network (100-2) on detection of an outage in the first network, in accordance with an embodiment of the present disclosure. In an aspect, the first network is a 5G network or a combination of 4G and 5G cellular networks. In another example, the second network is a 4G network. In another aspect, the first network is a 6G network or a combination of 5G and 6G cellular networks. In another example, the second network is a 5G network.

Referring to FIG. 1, the system 100 includes a user equipment (UE) 102, a first network entity 104, and a second network entity 106. In an embodiment, the first network entity 104 may correspond to a gNodeB in a 4G/5G combination core network 100-1 (first network). In an embodiment, the second network entity 106 may correspond to an eNodeB in a 4G core network 100-2 (second network). In an embodiment, the first network entity 104 and the second network entity 106 are configured to provide a cellular network to the user equipment 102 present in a cellular coverage range of either of the first network entity 104 or the second network entity 106 and thereby, the user equipment 102 avails voice and data services using the cellular network.

Further, the first network 100-1 includes various components such as an access and mobility management function (AMF) 108, a session management function (SMF)/gateway-control plane (GW-C) 110, user plane function (UPF)/gateway-user plane (GW-U) 112, a policy control function (PCF) 114, a unified data manager (UDM)/home subscriber server (HSS) 116, and other 5G network functions (NFs) 118.

Furthermore, the second network 100-2 may include a mobility management entity (MME) 120, a serving gateway (SGW) 122, a packet network data gateway (PGW) 124, a policy and charging rules function (PCRF) 126, a Diameter routing agent (DRA)/subscriber location function (SLF) 128, HSS 134, and other evolved packet core (EPC) nodes 130. The serving gateway (SGW) 122 handles the user data traffic, but isn't responsible for the signaling data used. It transports IP data from UE's to the LTE network. The SGW also routes incoming and outgoing IP packets and serves as an anchor for the UE when it moves from one eNodeB to another. The PGW 124 is the network node that connects an evolved packet core (EPC), to external IP networks. The PGW 124 routes packets to and from external IP networks. The PGW 124 also allocates an IP address to all UEs and enforces different policies regarding IP user traffic such as packet filtering. As depicted in FIG. 1, the network functions in the first network 100-1 are communicatively coupled over a data network 132-1. Similarly, the EPC nodes in the 4G core network 100-2 are communicatively coupled over a data network 132-2.

The home-subscriber-server (HSS) 116 is a database that stores and manages the subscriber profiles and service data. The HSS 116 contains information such as the subscriber's identity, authentication parameters, service preferences, location, and contact details. The HSS 116 also assigns an IP Multimedia Private Identity (IMPI) and one or more IP Multimedia Public Identities (IMPUs) to each subscriber, which are used for registration and authentication purposes.

The MME 120 is configured to manage the mobility of user equipments within the network. By managing the movement of user equipments, the MME ensures that they remain connected to the network and can continue to communicate seamlessly and without interruption.

As depicted in FIG. 1, the system 100 is employed at edge locations, a circle level, and a super core level. The user equipment 102 is in the coverage area of the 5G network, and therefore, attached to the 5G network. In an embodiment, where a current location of the user equipment 102 does not have 5G coverage, then the user equipment 102 may latch to the 4G network 100-2. In an embodiment, services to the user equipment 102 may be served by the 4G/5G combination core network 100-1 or the 4G core network 100-2 based on a UE-usage-type (UUT) attribute value pair (AVP) value. In an embodiment, the UUT AVP value is maintained/stored by the HSS 116. In an example, the UUT AVP value further includes an updated location value of the at least one UE.

Referring to FIG. 1, in an embodiment, the HSS 116 and/or the HSS 134 are queried by the MME 120 to decide whether the user equipment 102 is 4G only or migrated to the 4G/5G combination core network 100-1. The HSS 116 and/or the HSS 134 determine the UUT AVP value and return this information to the MME 120. In an embodiment, if the user equipment 102 is 4G only, the MME 120 is configured to select the 4G GW-C and GW-U. In another embodiment, if the user equipment 102 is migrated to the 4G/5G combination core, the MME 120 is configured to select the SMF and the UPF.

In such an embodiment, if any issue is anticipated in the 5G core network, then the circle-wise global flag in the HSS 116 is configured to return 4G as the UUT AVP value to the MME 120. Therefore, the MME 120 is configured to always select the 4G core network 100-2 and the user equipment 102 may latch on to the 4G core network 100-2. When the user equipment 102 is configured to transfer back to the 5G core network, when the circle-wise global flag is removed from the HSS 116 for that particular circle, and therefore, the user equipment 102 is configured to move back to the 5G core network.

In an embodiment, if any issue is anticipated in the 6G core network, then the circle-wise global flag in the HSS 116 is configured to return 5G as the UUT AVP value to the MME 120. Therefore, the MME 120 is configured to always select the 5G core network and the user equipment 102 may latch on to the 5G core network. When the user equipment 102 is configured to transfer back to the 6G core network, when the circle-wise global flag is removed from the HSS 116 for that particular circle, and therefore, the user equipment 102 is configured to move back to the 6G core network.

In an operative aspect, the mobility management entity (MME) is configured to send a query to the home subscriber server (HSS) for the UE usage type (UUT) of at least one UE. The HSS is configured to generate a UE-usage-type (UUT) attribute value pair (AVP) value corresponding to the at least one UE. The UUT AVP value may refer to a defined aspect or attribute related to the User Equipment (UE) and its usage type within a telecommunication network. In some implementations, the UUT AVP parameter may refer to the generation of cellular network (4G, 5G, 6G, etc.) that the UE is using or capable of connecting with. In an example, the HSS is configured to store UUT AVP values of the UEs connected to the network entity. The MME receives the UUT value in subscription information of the UE provided by the HSS. The mobility management entity (MME) is further configured to determine a type of the at least one UE based on the received UUT AVP value and switch the UE to the second network based on the determined type of the at least one UE. In an example, the determined type is a fourth-generation (4G) UE, or a fifth-generation (5G) UE, or a sixth-generation (6G) UE. The MME is configured to select a gateway-control plane (GW-C) or a gateway-user plane (GW-U) if the determined type of the at least one UE is 4G. The MME is configured to select a session management function (SMF) or a user plane function (UPF) if the determined type of the at least one UE is migrated to the 4G/5G. The MME is configured to map the UUT AVP value with a set of predefined UUT values stored in a table (Table 1) corresponding to a number of gateway planes connected with the first network and the second network. In an example, the number of gateway planes include a gateway-control plane (GW-C), a fully qualified domain name (FQDN), a gateway-user plane (GW-U), a session management function (SMF) or a user plane function (UPF).

If the received UUT AVP value is corresponds to NO and is mapped with at least one UUT values from the set of predefined UUT values stored in Table 1, the MME is configured to select at least one of the gateway-control plane (GW-C), the fully qualified domain name (FQDN), and the gateway-user plane (GW-U) connected with the second network.

If the received UUT AVP value is corresponds to 5G and mapped with at least one UUT values from the set of UUT values stored in Table 1, the MME is configured to select at least one of the gateway-control plane (GW-C) and the session management function (SMF) connected with the first network.

In an operative aspect, the system is configured to detect the outage based on a number of parameters. The outage includes an unexpected hardware or software outage of at least one serving cell in the first network. In an aspect, the hardware outages or software outages occur when components like servers, storage devices, or networking equipment fail or experience disruptions. Factors contributing to the hardware outages include component failure, power issues, overheating, natural disasters, human error, and software bugs. In an example, the number of parameters includes a reference signal received power (RSRP), a reference signal received quality (RSRQ), a received signal strength indicator (RSSI), and a signal-to-interference-plus-noise ratio (SINR). The RSRP is a parameter used in wireless communication systems to measure the quality of a received signal. The RSRP represents the power of a reference signal received by a receiver (UE), normalized to the power of a transmitted signal. A higher RSRP indicates a stronger signal, while a lower RSRP indicates a weaker signal. RSRP is commonly used to evaluate the quality of a received signal and estimate the amount of data that can be transmitted without errors. The UE usually measures RSRP or RSRQ based on the direction (RRC message) from the network and report the value. RSSI indicates the strength of the signal received by UE. RSSI considers not only the useful signal of a cell, but also all the secondary signal in the measured frequency range. For example, the RSSI value includes the signal of neighbouring base stations, internal and external interference, and noise. SINR measures signal quality by comparing a strength of a required signal compared to the unnecessary interference and noise. Mobile network operators seek to maximize SINR at all sites to deliver the best possible customer experience, either by transmitting at a higher power, or by minimizing the interference and noise.

In an aspect, the system is configured to detect the outage on edge location level, a circle level, and a super core level. In an example, if the outage is detected in a circle level node(s), then the HSS is configured to enable a circle-wise global flag and sets the UUT AVP value as 4G for the user equipments latched to the circle level node(s). In an example, the circle level node(s) includes a public land mobile network (PLMN). The HSS is configured to update/set flags for a table (having UUT as attributes and values as network (4G or 5G) for many operations, including adjusting server parameters, adjusting options, and configuring and tuning an instance (outage detection on circle level). When the HSS sets, removes, or modifies a flag (for example, circle-wise global flag) for the outage detection, the table might be restarted. The flag value is then persisted for the instance until the HSS remove it. In an operative aspect, if any issue is anticipated in the 5G core network, then the circle-wise global flag in the HSS 116 always return 4G as the UUT AVP value to the MME 120. Therefore, the MME 120 always selects the 4G core network 100-2 and the user equipment 102 will be latched on to the 4G core network 100-2.

Further, the HSS is configured to disable the circle-wise global flag on resolving the outage in the circle level node(s), thereby enabling transfer of the UEs to the circle level node(s). When the user equipment 102 may have to be brought back to the 5G core network, then the circle-wise global flag may be removed from the HSS 116 for that particular circle, and therefore, the user equipment 102 may move back to the 5G core network. In an aspect, the super core level includes at least one data center. The system is configured to detect the hardware and software outages in the data center.

In an example, if the outage is detected in super core level node(s), the HSS is configured to enable a global flag and sets the UUT AVP value as 4G for the user equipments latched to the super core level node(s). The HSS is configured to update/set flags for the table (having UUT as attributes and value as network (4G or 5G or 6G) for many operations, including adjusting server parameters, adjusting options, and configuring and tuning an instance (outage detection). When the HSS sets, removes, or modifies a flag (for example, global flag) for the outage detection, the table might be restarted. The flag value is then persisted for the instance until the HSS remove it. The UUT AVP value indicates the usage characteristics of the UE that enables the selection of a core network. The global flag may set a value of the UUT as 4G for all subscribers such as the user equipment 102 latched in that particular circle as well as for subscribers belonging to circles parented by the impacted super core location. For example, if UPF 112 of location 1 is not serviceable and PCF 114 of location 2 is also unavailable, the HSS 116/134 is configured to set the value of the UUT as 4G for all subscribers latched in the location 1, which is configured to also include subscribers of other circles roaming in the location 1, and for all subscribers with home PLMN belonging to the location 2 as well as circles parented to the location 2. In this scenario, the value of the UUT is returned to the impacted circle's MMEs 120, in this example, to the MMEs of location 1. Hence, subscribers latched in location 1 are served in 4G core network. Further, the HSS 116/134 returns the value of the UUT to the MMEs 120 affected because of PCF at location 2 not being serviceable.

The HSS is configured to disable the global flag on resolving the outage in the super core level node(s), thereby enabling transfer of the at least one UE to the super core level node(s). In an embodiment, on restoration of the impacted super core level nodes, i.e. the PCF 114, global flag (settings) of the HSS 116/134 again overwrite the value of the UUT and return the value of the UUT as 5G to the affected MMEs 120. For all impacted 5G subscribers, the affected MMEs 120 gradually selects the 5G core network (i.e. 100-1) for new attach requests coming from user equipments such as 102 over 4G radio.

Although FIG. 1 shows exemplary components of the system 100, in other embodiments, the system 100 may include fewer components, different components, differently arranged components, or additional functional components than depicted in FIG. 1. Additionally, or alternatively, one or more components of the system 100 may perform functions described as being performed by one or more other components of the system 100.

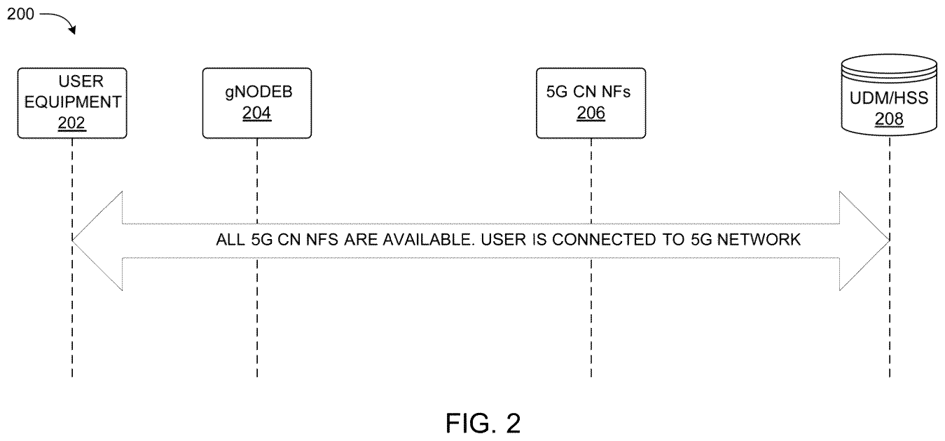

FIG. 2 illustrates an exemplary representation 200 of a connection between a user equipment and a network, in accordance with an embodiment of the present disclosure.

Referring to FIG. 2, a user equipment 202 is connected to a network entity 204 such as the gNodeB. In an embodiment, when all 5G core network NFs 206 are available and there exists no issue, the UDM/HSS 208 returns the UUT AVP value as 5G, and therefore, the user equipment 202 is connected to the 5G network. It is appreciated that the user equipment 202, the network entity 204, and the UDM/HSS 208 are similar to the user equipment 102, the network entity 104, and the UDM/HSS 116 of FIG. 1, respectively, in their functionality. Further, the 5G NFs 206 are similar to the network functions displayed in 100-1 of FIG. 1 in their functionality.

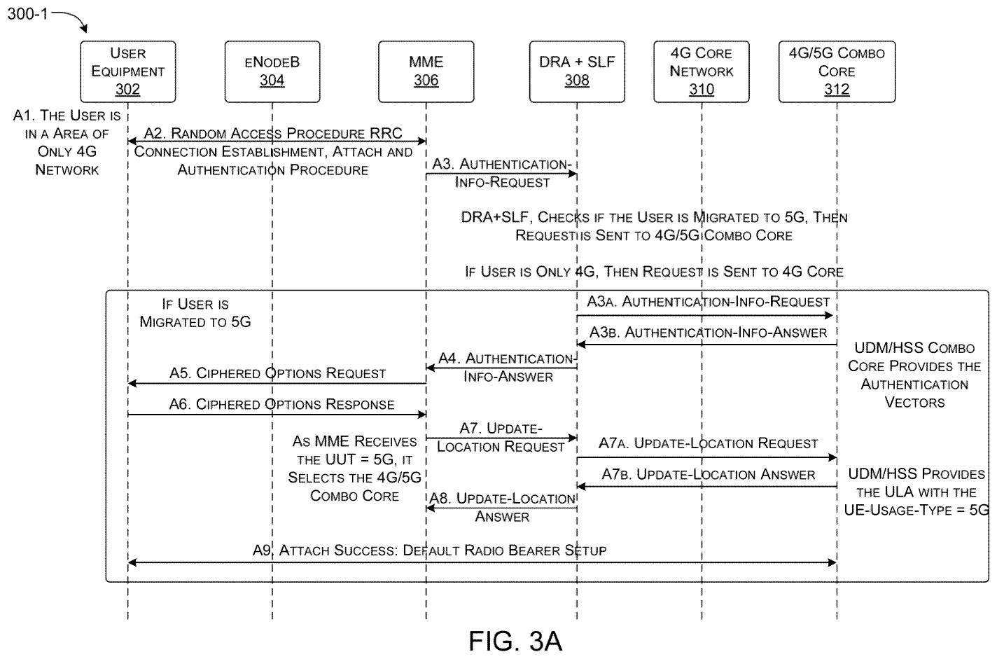

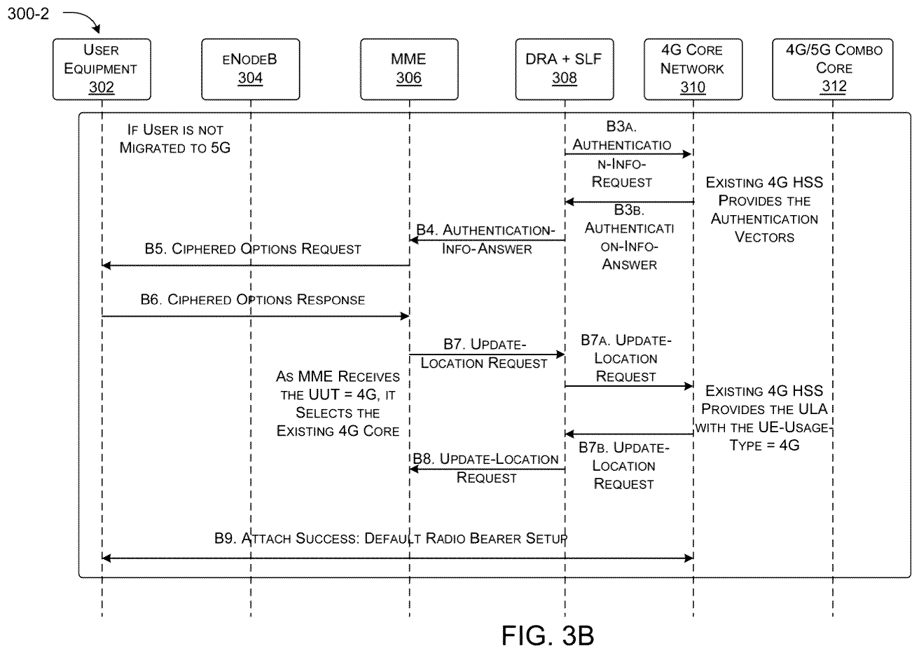

FIGS. 3A-3B illustrate exemplary signal flow diagrams (300-1, 300-2) for implementing a switchover of the UE between the networks, in accordance with embodiments of the present disclosure.

Referring to FIG. 3A, step A1 includes determining that a user equipment 302 is present in a coverage area of a 4G network. Further, at step A2, a random access procedure is initiated, where a radio resource control (RRC) connection is established between the user equipment 302 and an MME 306. In an embodiment, at step A2, an attach and authentication procedure is also initiated. In an embodiment, the user equipment 302 is communicatively coupled to the MME 306 via a network entity 304 such as the eNodeB.

Furthermore, at step A3, the MME 306 is configured to send an authentication information request to DRA/SLF 308. In an embodiment, the DRA/SLF 308 determines whether the user equipment 302 is 4G only or migrated to 4G/5G combination core network. Based on the determination, the DRA/SLF 308 transmits the authentication information request to the respective HSS in the core network. For example, if the DRA/SLF 308 determines that the user equipment 302 is migrated to 4G/5G combination core, then the DRA/SLF 308 transmits the authentication information request to a 4G/5G combination core network 312 at step A3a. In another embodiment, the if DRA/SLF 308 determined that the user equipment 302 is 4G only, then the DRA/SLF 308 transmits the authentication information request to a 4G core network 310 at step B3a, which is explained with reference to FIG. 3B.

Referring to FIG. 3A, in response to receiving the authentication information request, UDM/HSS in the 4G/5G combination core network 312 is configured to retrieve and provide relevant authentication vectors to the DRA/SLF 308 in an authentication information answer at step A3b. Thereafter, at step A4, the DRA/SLF 308 is configured to send the authentication information answer to the MME 306. Based on the authentication information answer, the MME 306 is configured to send a ciphered options request to the user equipment 302 at step A5. In response, at step A6, the user equipment 302 is configured to send a ciphered options response to the MME 306.

Further, at step A7, the MME 306 is configured to send an update location request to the DRA/SLF 308. In this embodiment, the DRA/SLF 308 is configured to send the update location request to the 4G/5G combination core network 312, and specifically to the UDM/HSS within the 4G/5G combination core network 312 at step A7a. In an embodiment, the UDM/HSS is configured to retrieve and provide UUT AVP value as an update location answer to the DRA/SLF 308 at step A7b. In this particular scenario, the UUT AVP value is 5G. Furthermore, the DRA/SLF 308 is configured to send the update location answer to the MME 306 at step A8. In an embodiment, based on the update location answer (i.e. the UUT AVP value), the MME 306 is configured to select the 4G/5G combination core network 312 for the user equipment 302, and at step A9, the user equipment 302 is successfully latched on to the 4G/5G combination core network 312.

Referring to FIG. 3B, if at step A3, the DRA/SLF 308 determines that the user equipment 302 is 4G only, then the DRA/SLF 308 transmits the authentication information request to the 4G core network 310 at step B3a. In response to receiving the authentication information request, the existing HSS (for example, the HSS 134 of FIG. 1) in the 4G core network 310 is configured to retrieve and provide relevant authentication vectors to the DRA/SLF 308 in an authentication information answer at step B3b. Thereafter, at step B4, the DRA/SLF 308 is configured to send the authentication information answer to the MME 306. Based on the authentication information answer, the MME 306 is configured to send a ciphered options request to the user equipment 302 at step B5. In response, at step B6, the user equipment 302 is configured to send a ciphered options response to the MME 306.

Further, at step B7, the MME 306 is configured to send an update location request to the DRA/SLF 308. In this embodiment, the DRA/SLF 308 is configured to send the update location request to the 4G core network 312, and specifically to the HSS 134 within the 4G core network 310 at step B7a. In an embodiment, the existing HSS 134 is configured to retrieve and provide UUT AVP value as an update location answer to the DRA/SLF 308 at step B7b. In this particular scenario, the UUT AVP value is 4G. Furthermore, the DRA/SLF 308 is configured to send the update location answer to the MME 306 at step B8. In an embodiment, based on the update location answer (i.e. the UUT AVP value), the MME 306 is configured to select the 4G core network 310 for the user equipment 302, and at step B9, the user equipment 302 is successfully latched on to the 4G core network 310.

It may be appreciated that the user equipment 302, the network entity 304, the MME 306, and the DRA/SLF 308 are similar to the user equipment 102, the network entity 106, the MME 120, and the DRA/SLF 128 of FIG. 1, respectively, in their functionality. Further, the 4G core network 310 and the 4G/5G combination core network 312 are similar to 100-2 and 100-1 of FIG. 1, respectively.

Further, it may be appreciated that the steps shown in FIGS. 3A-3B are merely illustrative. Other suitable steps may be used, if desired. Moreover, the steps of the flow diagrams (300-1, 300-2) may be performed in any order and may include additional steps, without departing from the scope of the current disclosure.

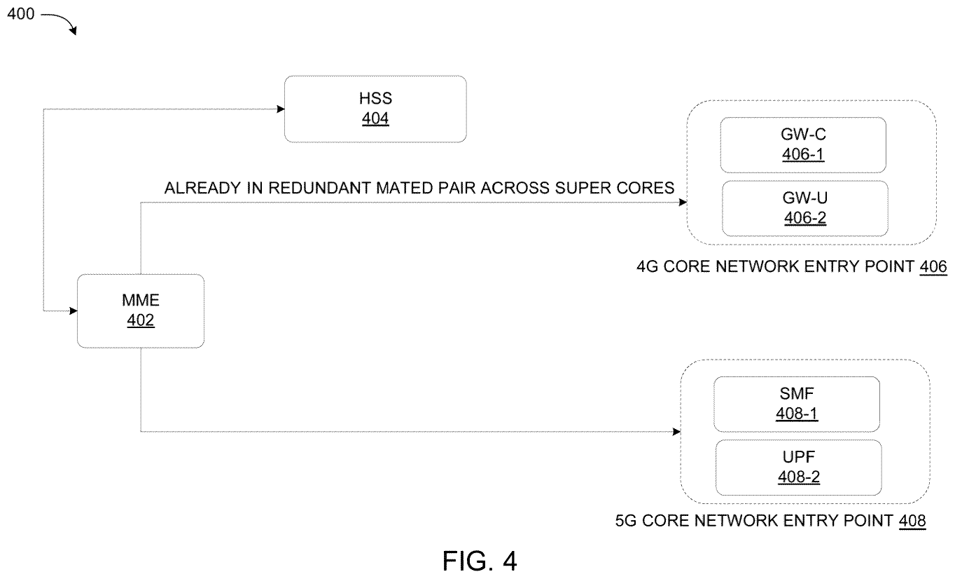

FIG. 4 illustrates an exemplary representation 400 of communication between mobility management entity (MME), home subscriber server (HSS), and network entry points, in accordance with an embodiment of the present disclosure.

Referring to FIG. 4, an MME 402 communicates with an HSS 404 to determine whether user equipment(s) are 4G only or migrated to 4G/5G combination core network. The HSS 404 is configured to retrieve this information and respond to the MME 402 with a UUT AVP value, where if the UUT AVP value is 4G only, then the MME 402 establishes a connection between the user equipment(s) and 4G core network entry point 406, and if the UUT AVP value if 4G/5G combination core, then the MME 402 establishes a connection between the user equipment(s) and the 4G/5G combination core network entry point 408. As depicted in FIG. 4, the 4G core network entry point 406 includes a GW-C 406-1 and a GW-U 406-2, and the 4G/5G combination core network 408 includes an SMF 408-1 and a UPF 408-2.

It may be appreciated that the MME 402, the HSS 404, the GW-C 406-1 and SMF 408-1, and the GW-U 406-2 and UPF 408-2 are similar to the MME 120, the HSS 116/134, the SMF/GW-C 110, and the UPF/GW-U 112 of FIG. 1, respectively, in their functionality.

Although FIG. 4 shows exemplary components of the representation 400, in other embodiments, the representation 400 may include fewer components, different components, differently arranged components, or additional functional components than depicted in FIG. 4. Additionally, or alternatively, one or more components of the representation 400 may perform functions described as being performed by one or more other components of the representation 400.

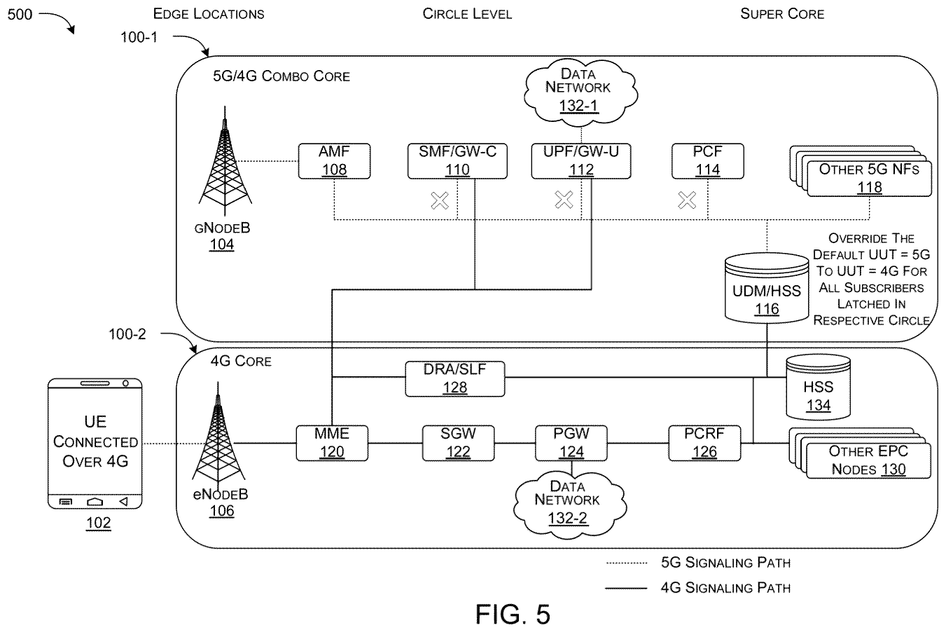

FIG. 5 illustrates an exemplary architecture for a system 500 for implementing a circle level service impact for access and mobility management function (AMF), session management function (SMF), and user plane function (UPF) network functions, in accordance with an embodiment of the present disclosure. In an aspect, the circle level includes a policy control function (PCF), and a public land mobile network (PLMN). The system is configured to detect the hardware and software outages in the PLMN. It may be appreciated that the reference numerals used in FIG. 5 correspond to those used in FIG. 1 for the sake of clarify and ease of explanation.

Referring to FIG. 5, in an embodiment, if circle level nodes (session management function (SMF), user plane function (UPF) and policy control function (PCF)) are impacted or have an issue in the 4G/5G combination core network 100-1, then a circle-wise global flag is configured in the HSS 116/134. In such an embodiment, the circle-wise global flag sets a value of the UUT as 4G for all subscribers such as the user equipment 102 latched in that particular circle. The circle level nodes that are impacted in the 4G/5G combination core network 100-1 may include, but not be limited to, the PCF 114, the SMF 110, and the UPF 112, as also depicted in FIG. 5.

As an example but not limitation, if SMFs of location 1 are impacted, the HSS 116/134 is configured to set the value of the UUT as 4G for all subscribers latched in the location 1, which also includes subscribers of other circles roaming in the location 1. In this scenario, the value of the UUT is returned to the impacted circle's MMEs 120, in this example, to the MMEs of location 1. Further, the MMEs 120 of location 1 is configured to select the existing 4G core network 100-2 to serve 5G home subscribers present in the location 1, as well as other circle's subscribers roaming in the location 1, for example, location 2 public land mobile network (PLMN) subscriber in location 1. On restoration of the impacted circle level nodes, in this example, the SMFs of location 1, the HSS 116/134 is configured to overwrite the value of the UUT and return the value of the UUT as 5G to the MME 120 (i.e. the MMEs of location 1). For all 5G subscribers in location 1, the MMEs 120 gradually selects the 5G core network (i.e. 100-1) for new attach requests coming from user equipments such as 102 over 4G radio.

Although FIG. 5 shows exemplary components of the system architecture 500, in other embodiments, the system 500 may include fewer components, different components, differently arranged components, or additional functional components than depicted in FIG. 5. Additionally, or alternatively, one or more components of the system 500 may perform functions described as being performed by one or more other components of the system 500.

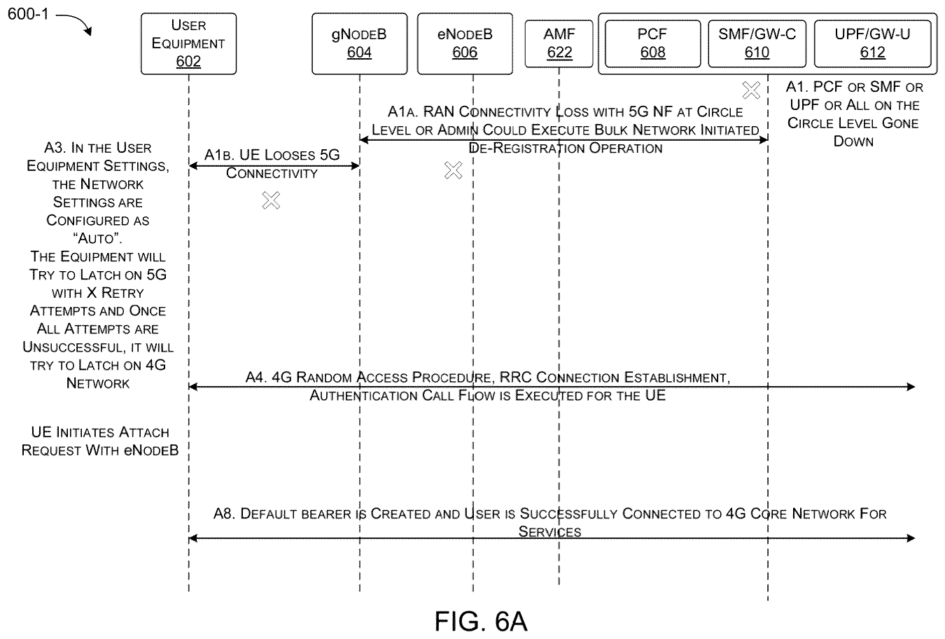

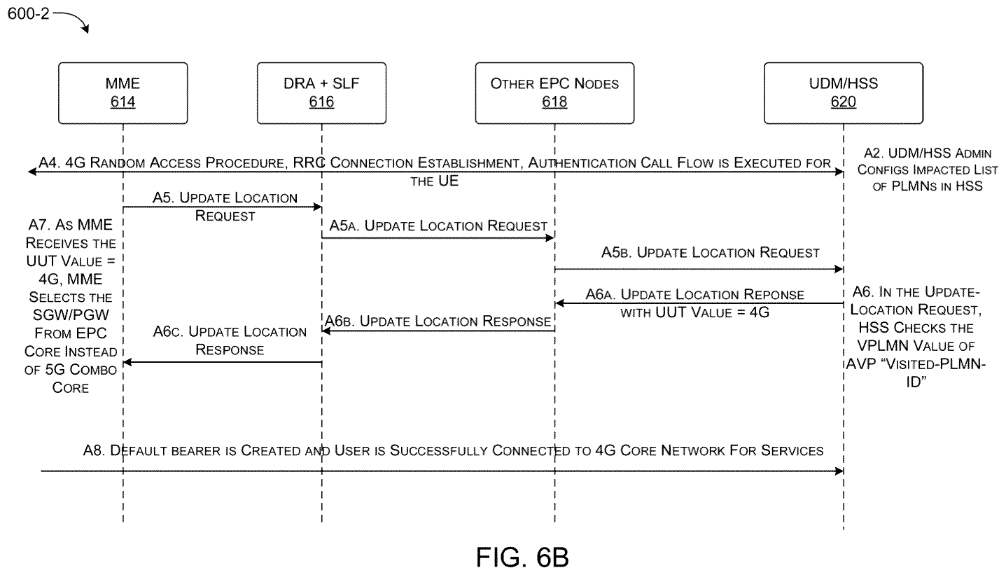

FIGS. 6A-6B illustrate exemplary sequence flow diagrams (600-1, 600-2) of a method for implementing a circle level service impact for SMF, PCF, and UPF network functions, in accordance with embodiments of the present disclosure. It may be appreciated that the method may be explained with reference to steps of FIGS. 6A and 6B interchangeably. In an embodiment, the user equipment 602 is communicatively coupled to the MME 614 via a network entity 606 such as the eNodeB 606 or coupled to the AMF 622 via a network entity 604 such as the gNodeB 604.

At step A1, it is determined by the system 100 that circle level nodes are impacted, for example, PCF 608, SMF/GW-C 610, UPF/GW-U 612, have gone down. In response, at step A1a, the impacted circle level nodes is configured to communicate radio access network (RAN) connectivity loss to a first network entity 604 such as gNodeB. In another embodiment, an administrator is configured to execute bulk network initiates de-registration operation. Thereafter, a connected user equipment 602 lost connectivity to 5G network, at step A1b. Further, at step A2, an administrator of the UDM/HSS 620 configures a list of impacted PLMNs in the HSS 620 to override a value of UTT from 5G to 4G. In an embodiment, the administrator of the UDM/HSS 620 is configured to check for visited PLMN identities (IDs) in an update location request. In an embodiment, this configuration is replicated in all affected circles.

Referring to FIG. 6A, at step A3, the user equipment 602 is configured to try to latch on 5G network with ‘x’ retry attempts based on network settings being on automatic. In case all the retry attempts are unsuccessful, the user equipment 602 is configured to try to latch on to 4G network. Therefore, in such an embodiment, the user equipment 602 is configured to initiate attach request with a second network entity 606 such as the eNodeB.

Further, at step A4, random access procedure is initiated for the user equipment 602. The random access procedure includes establishing RRC connection and executing authentication call flow for the user equipment 602. In response thereto, at step A5, MME 614 is configured to send an update location request to DRA/SLF 616. At steps A5a and A5b, the DRA/SLF 616 is configured to send the update location request to other EPC nodes 618, and other EPC nodes 618 is configured to send the update location request to UDM/HSS 620, respectively.

Furthermore, at step A6, in response to receiving the update location request, the HSS 620 is configured to check the visited PLMN value of AVP “visited-PLMN-ID.” If the configuration for respective PLMN is present, then the HSS 620 overrides the user's default UUT from 5G to 4G. The HSS 620 is configured to send this updated configuration of UUT value in an update location answer/response to the DRA/SLF 616 via other EPC nodes 618 in steps A6a and A6b. In an embodiment, if the configuration for the respective PLMN is not present, the HSS 620 is configured to send the UUT value from user equipment's profile. At step A6c, the DRA/SLF 616 is configured to send the update location response to the MME 614.

Referring to FIG. 6B, at step A7, in response to receiving the update location response (i.e., UUT value as 4G), the MME 614 selects the 4G network instead of 5G network. Specifically, the MME 614 selects SGW/PGW from EPC core network. Therefore, a default bearer is created and the user equipment 602 is successfully connected to 4G core network for services.

It may be appreciated that the steps shown in FIGS. 6A-6B are merely illustrative. Other suitable steps may be used, if desired. Moreover, the steps of the flow diagrams (600-1, 600-2) may be performed in any order and may include additional steps, without departing from the scope of the current disclosure.

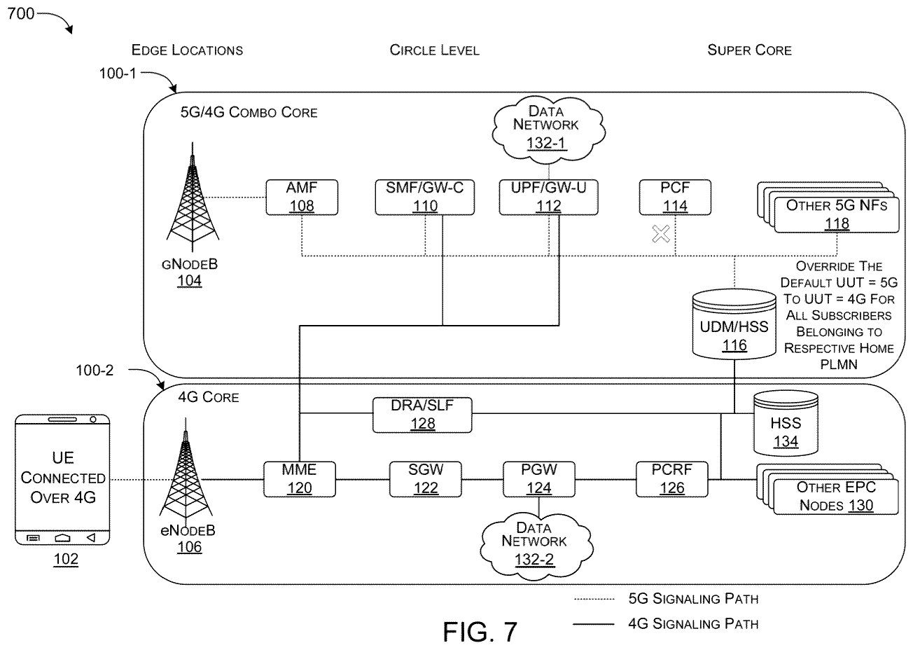

FIG. 7 illustrates an exemplary architecture of a system 700 for implementing a super core level service impact for policy control function (PCF), in accordance with an embodiment of the present disclosure. It may be appreciated that the reference numerals used in FIG. 7 correspond to those used in FIG. 1 for the sake of clarify and ease of explanation.

Referring to FIG. 7, in an embodiment, if super core level nodes are impacted or have an issue in the 4G/5G combination core network 100-1, then a global flag may be configured in the HSS 116/134. In such an embodiment, the global flag is set a value of the UUT as 4G for all subscribers such as the user equipment 102 with home PLMN belonging to that node. The super core level node that may be impacted in the 4G/5G combination core network 100-1 may include, but not be limited to, the PCF 114, as also depicted in FIG. 7.

As an example but not limitation, if the PCF 114 of location 1 is impacted or is unavailable, the HSS 116/134 may set the value of the UUT as 4G for all subscribers with home PLMN belonging to the location 1 as well as circles parented to the location 1. In this scenario, the value of the UUT may be returned to all affected MMEs 120. This will overwrite the original UUT value in the subscriber profile for subscribers belonging to the home PLMNs which is served by the super core impacted, i.e. the PCF 114.

In this manner, the affected MMEs 120 of those 5G subscribers are configured to select the existing 4G core network, whereas other 5G subscribers of the non-impacted circles continue to be served in the 5G core network.

On restoration of the impacted super core level nodes, i.e. the PCF 114, global settings of the HSS 116/134 again overwrites the value of the UUT and return the value of the UUT as 5G to the affected MME 120. For all impacted 5G subscribers, the affected MMEs 120 gradually selects the 5G core network (i.e. 100-1) for new attach requests coming from user equipments such as 102 over 4G radio.

Although FIG. 7 shows exemplary components of the system 700, in other embodiments, the system 700 may include fewer components, different components, differently arranged components, or additional functional components than depicted in FIG. 7. Additionally, or alternatively, one or more components of the system 700 may perform functions described as being performed by one or more other components of the system 700.

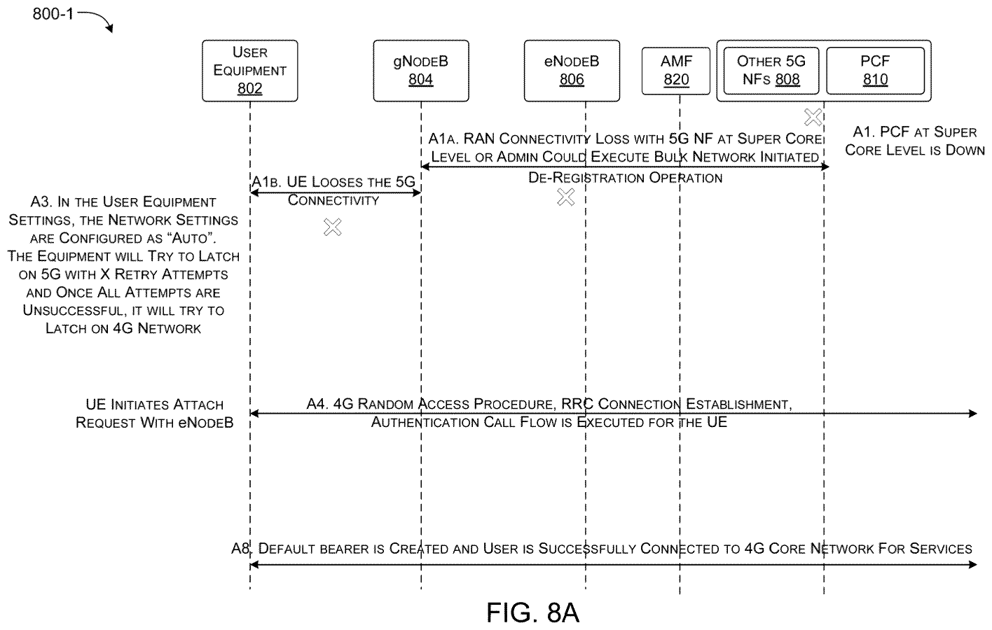

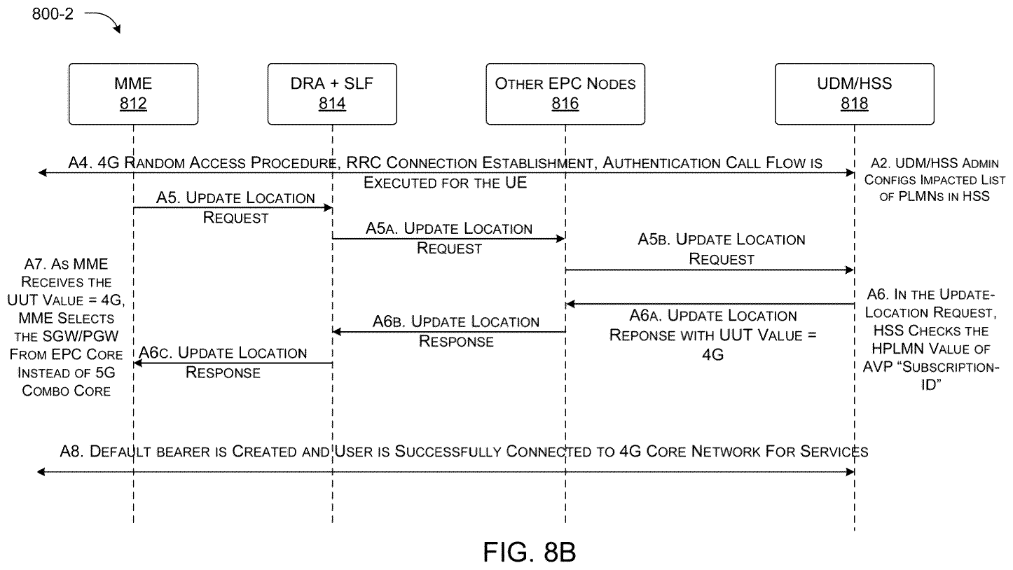

FIGS. 8A-BB illustrate exemplary sequence flow diagrams (800-1, 800-2) of a method for implementing a super core level service impact for PCF, in accordance with embodiments of the present disclosure. It may be appreciated that the method may be explained with reference to steps of FIGS. 8A and 8B interchangeably. In an embodiment, the user equipment 802 is communicatively coupled to the MME 812 via a network entity 806 such as the eNodeB 806 or coupled to the AMF 820 via a network entity 804 such as the gNodeB 804.

At step A1, the system 100 determines that the outage is occurred at super core level and super core level nodes are impacted, for example, the PCF 810, and/or other 5G NFs 808 have gone down. In response, at step A1a, the impacted super core level nodes communicates RAN connectivity loss to a first network entity 804 such as gNodeB. In another embodiment, an administrator may execute bulk network initiates de-registration operation. Thereafter, a connected user equipment 802 lost connectivity to 5G network, at step A1b. Further, at step A2, an administrator of the UDM/HSS 818 configures a list of impacted PLMNs in the HSS 818 to override a value of UTT from 5G to 4G. In an embodiment, the administrator of the UDM/HSS 818 checks for home PLMN from international mobile subscriber identity (IMSI) prefix. In an embodiment, this configuration may be required only on the UDM/HSS 818 service the respective core.

Referring to FIG. 8A, at step A3, the user equipment 802 is configured to try to latch on 5G network with ‘x’ retry attempts based on network settings being on automatic. In case all the retry attempts are unsuccessful, the user equipment 802 is configured to try to latch on to 4G network. Therefore, in such an embodiment, the user equipment 802 is configured to initiate attach request with a second network entity 806 such as the eNodeB.

Further, at step A4, a random access procedure is initiated for the user equipment 802. The random access procedure includes establishing RRC connection and executing authentication call flow for the user equipment 802. In response thereto, at step A5, MME 812 may send an update location request to DRA/SLF 814. At steps A5a and A5b, the DRA/SLF 814 sends the update location request to other EPC nodes 816, and other EPC nodes 816 sends the update location request to UDM/HSS 818, respectively.

Furthermore, at step A6, in response to receiving the update location request, for the respective PLMN, the HSS 818 checks the home PLMN value of AVP “subscription-ID” that includes the IMSI value. If the configuration for respective PLMN is present, then the HSS 818 overrides the user's default UUT from 5G to 4G. The HSS 818 is configured to send this updated configuration of UUT value in an update location answer/response to the DRA/SLF 814 via other EPC nodes 816 in steps A6a and A6b. At step A6c, the DRA/SLF 814 is configured to send the update location response to the MME 812.

Referring to FIG. 8B, at step A7, in response to receiving the update location response (i.e., UUT value as 4G), the MME 812 is configured to select the 4G network instead of 5G network. Specifically, the MME 812 selects SGW/PGW from EPC core network. Therefore, a default bearer is created and the user equipment 802 is successfully connected to 4G core network for services.

It may be appreciated that the steps shown in FIGS. 8A-8B are merely illustrative. Other suitable steps may be used, if desired. Moreover, the steps of the flow diagrams (800-1, 800-2) may be performed in any order and may include additional steps, without departing from the scope of the current disclosure.

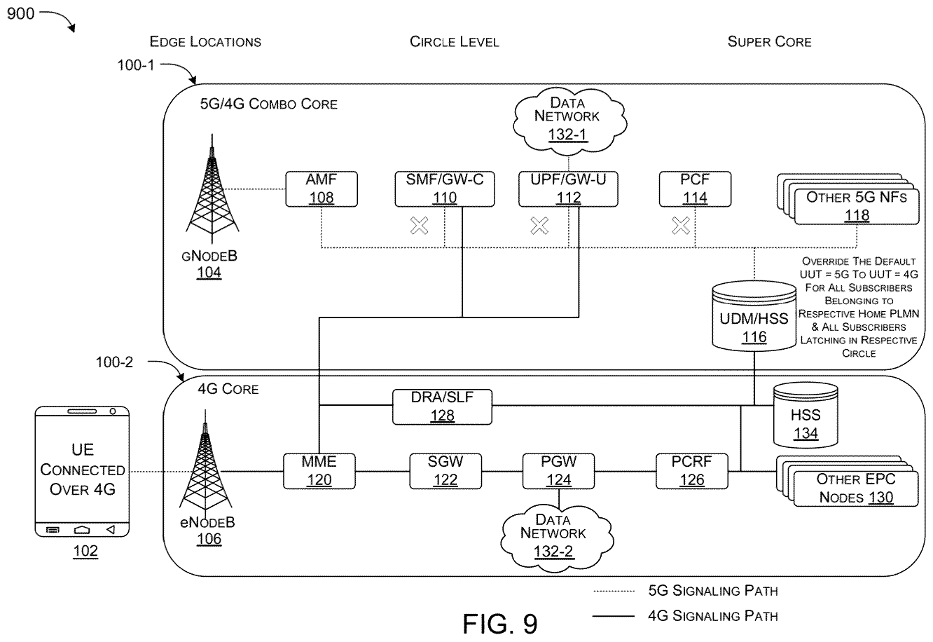

FIG. 9 illustrates an exemplary architecture of a system 900 for implementing a circle level service impact as well as a super core level service impact, in accordance with an embodiment of the present disclosure. It may be appreciated that the reference numerals used in FIG. 9 correspond to those used in FIG. 1 for the sake of clarify and ease of explanation.

Referring to FIG. 9, in an embodiment, if circle level nodes as well as super core level nodes are impacted or have an issue in the 4G/5G combination core network 100-1, then a global flag may be configured in the HSS 116/134. In such an embodiment, the global flag may set a value of the UUT as 4G for all subscribers such as the user equipment 102 latched in that particular circle as well as for subscribers belonging to circles parented by the impacted super core location. The circle level nodes that are impacted in the 4G/5G combination core network 100-1 may include, but not be limited to, the SMF 110, and the UPF 112, and the super core level nodes that are impacted may include, but not be limited to, the PCF 114, as also depicted in FIG. 9.

As an example but not limitation, if UPF 112 of location 1 is not serviceable and PCF 114 of location 2 is also unavailable, the HSS 116/134 is configured to set the value of the UUT as 4G for all subscribers latched in the location 1, which is configured to also include subscribers of other circles roaming in the location 1, and for all subscribers with home PLMN belonging to the location 2 as well as circles parented to the location 2. In this scenario, the value of the UUT is returned to the impacted circle's MMEs 120, in this example, to the MMEs of location 1. Hence, subscribers latched in location 1 are served in 4G core network. Further, the HSS 116/134 returns the value of the UUT to the MMEs 120 affected because of PCF at location 2 not being serviceable.

In an embodiment, on restoration of the impacted super core level nodes, i.e. the PCF 114, global flag (settings) of the HSS 116/134 again overwrite the value of the UUT and return the value of the UUT as 5G to the affected MMEs 120. For all impacted 5G subscribers, the affected MMEs 120 gradually selects the 5G core network (i.e. 100-1) for new attach requests coming from user equipments such as 102 over 4G radio.

In an embodiment, on restoration of the impacted circle level nodes, in this example, the UPF of location 1, the HSS 116/134 is configured to again overwrite the value of the UUT and return the value of the UUT as 5G to the MME 120 (i.e. the MMEs of location 1). For all 5G subscribers in location 1, the MMEs 120 gradually selects the 5G core network (i.e. 100-1) for new attach requests coming from user equipments such as 102 over 4G radio.

Although FIG. 9 shows exemplary components of the system 900, in other embodiments, the system 900 may include fewer components, different components, differently arranged components, or additional functional components than depicted in FIG. 9. Additionally, or alternatively, one or more components of the system 900 may perform functions described as being performed by one or more other components of the system 900.

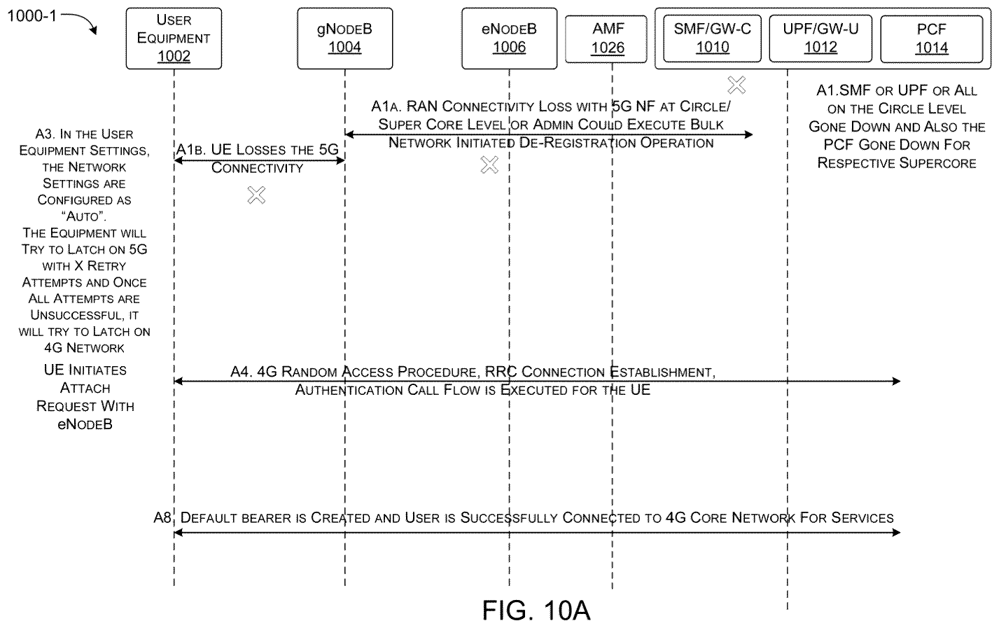

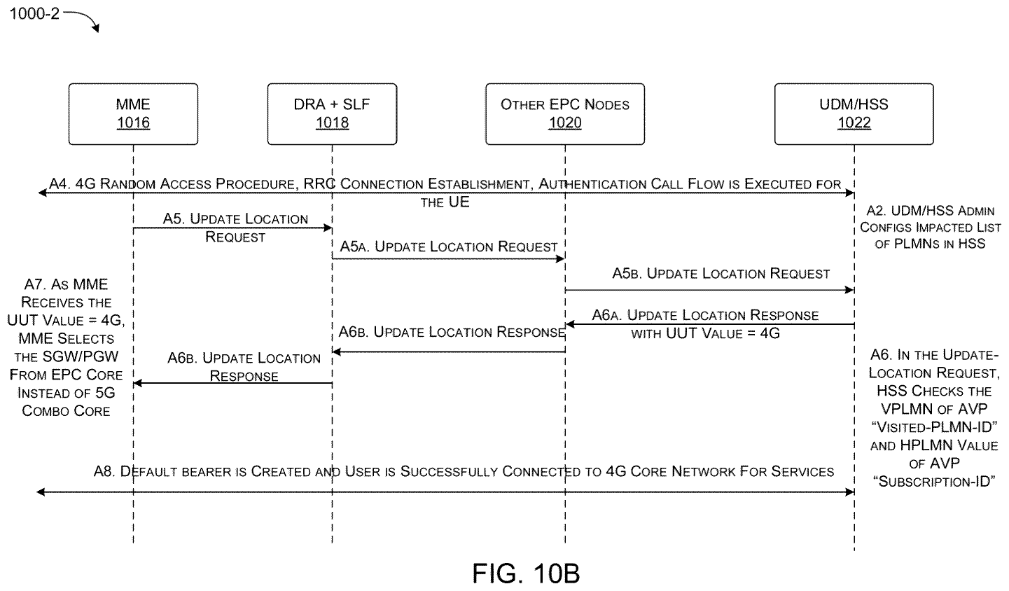

FIGS. 10A-10B illustrate exemplary sequence flow diagrams (1000-1, 1000-2) of a method for implementing a circle level service impact as well as a super core level service impact, in accordance with embodiments of the present disclosure. It may be appreciated that the method may be explained with reference to steps of FIGS. 10A and 10B interchangeably. In an embodiment, the user equipment 1002 is communicatively coupled to the MME 1016 via a network entity 1006 such as the eNodeB 1006 or coupled to the AMF 1026 via a network entity 1004 such as the gNodeB 1004.

At step A1, the system 100 determines that the circle level nodes are impacted, for example, SMF/GW-C 1010, UPF/GW-U 1012 have gone down, as well as super core level nodes are impacted, for example PCF 1014 has gone down. In response, at step A1a, the impacted circle level nodes and super core level nodes communicate RAN connectivity loss to a first network entity 1004 such as gNodeB. In another embodiment, an administrator is configured to execute bulk network initiates de-registration operation. Thereafter, a connected user equipment 1002 lost connectivity to 5G network, at step A1b. Further, at step A2, an administrator of the UDM/HSS 1022 configures a list of impacted PLMNs in the HSS 1022 to override a value of UTT from 5G to 4G. In an embodiment, the administrator of the UDM/HSS 1022 is configured to check for visited PLMN IDs in an update location request and for home PLMN from the IMSI prefix as well as PLMNs for all circles served by the respective super core, i.e. PCF 1014. In an embodiment, this configuration is replicated in all affected circles.

Referring to FIG. 10A, at step A3, the user equipment 1002 is configured to try to latch on 5G network with ‘x’ retry attempts based on network settings being on automatic. In case all the retry attempts are unsuccessful, the user equipment 1002 is configured to try to latch on to 4G network. Therefore, in such an embodiment, the user equipment 1002 is configured to initiate attach request with a second network entity 1006 such as the eNodeB.

Further, at step A4, random access procedure may be initiated for the user equipment 1002. The random access procedure includes establishing RRC connection and executing authentication call flow for the user equipment 1002. In response thereto, at step A5, MME 1016 is configured to send an update location request to DRA/SLF 1018. At steps A5a and A5b, the DRA/SLF 1018 is configured to send the update location request to other EPC nodes 1020, and other EPC nodes 1020 is configured to send the update location request to UDM/HSS 1022, respectively.

Furthermore, at step A6, in response to receiving the update location request, the HSS 1022 is configured to check the visited PLMN value of AVP “visited-PLMN-ID,” and for the respective PLMN, the HSS 1022 is configured to check the home PLMN value of AVP “subscription-ID.” If the configuration for respective PLMN is present, then the HSS 1022 is configured to override the user's default UUT from 5G to 4G. The HSS 1022 is configured to send this updated configuration of UUT value in an update location answer/response to the DRA/SLF 1018 via other EPC nodes 1020 in steps A6a and A6b. At step A6c, the DRA/SLF 1018 is configured to send the update location response to the MME 1016.

Referring to FIG. 10B, at step A7, in response to receiving the update location response (i.e., UUT value as 4G), the MME 1016 is configured to select the 4G network instead of 5G network. Specifically, the MME 1016 is configured to select SGW/PGW from EPC core network. Therefore, a default bearer is created and the user equipment 1002 is successfully connected to 4G core network for services.

It may be appreciated that the steps shown in FIGS. 10A-10B are merely illustrative. Other suitable steps may be used, if desired. Moreover, the steps of the flow diagrams (1000-1, 1000-2) may be performed in any order and may include additional steps, without departing from the scope of the current disclosure.

A person of ordinary skill in the art will readily ascertain that the illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

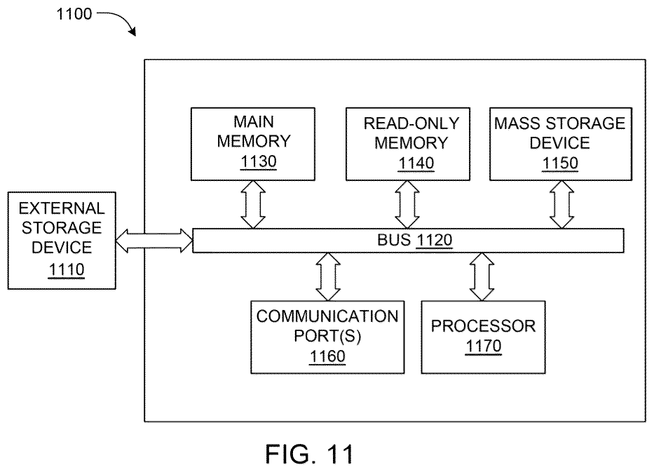

FIG. 11 illustrates an exemplary computer system 1100 in which or with which embodiments of the present disclosure may be implemented. As shown in FIG. 11, the computer system 1100 may include an external storage device 1110, a bus 1120, a main memory 1130, a read-only memory 1140, a mass storage device 1150, communication port(s) 1160, and a processor 1170. A person skilled in the art will appreciate that the computer system 1100 may include more than one processor and communication port(s). The processor 1170 may include various modules associated with embodiments of the present disclosure. The communication port(s) 1160 may be any of an RS-232 port for use with a modem-based dialup connection, a 10/100 Ethernet port, a Gigabit or 10 Gigabit port using copper or fibre, a serial port, a parallel port, or other existing or future ports. The communication port(s) 1160 may be chosen depending on a network, such a Local Area Network (LAN), Wide Area Network (WAN), or any network to which the computer system 1100 connects. The main memory 1130 may be random-access memory (RAM), or any other dynamic storage device commonly known in the art. The read-only memory 1140 may be any static storage device(s). The mass storage device 1150 may be any current or future mass storage solution, which can be used to store information and/or instructions.

The bus 1120 communicatively couples the processor 1170 with the other memory, storage, and communication blocks. Optionally, operator and administrative interfaces, e.g., a display, keyboard, and a cursor control device, may also be coupled to the bus 1120 to support direct operator interaction with the computer system 1100. Other operator and administrative interfaces may be provided through network connections connected through the communication port(s) 1160. Components described above are meant only to exemplify various possibilities. In no way should the aforementioned exemplary computer system 1100 limit the scope of the present disclosure.

Therefore, the present disclosure provides overriding the UUT value based on 5G core network unavailability flag at different levels like circle level, super core level, etc. The disclosed solution is applicable to multiple cores of different types, for example, between 4G and 5G cores. The disclosed solution is also applicable to multiple cores of different types, for example, between 5G and 6G cores. The solution is applicable to multiple cores of same type, for example, multiple 5G cores identified as core IDs. The same is for multiple 4G cores. The switchover between 5G and 6G may be subject to possibility that 6G may be utilizing existing infrastructure of 4G/5G.

In an embodiment of the present invention, the first network is a 5G network or a combination of 4G and 5G cellular networks. Furthermore, the second network is a 4G network.

In an alternate embodiment, the first network may be a 6G network or a combination of 5G and 6G cellular networks. Furthermore, the second network is a 5G network. In this, the associated infrastructure parameters and Intelligent reflecting surfaces (IRS), capable for 6G network in addition to the 5G network structure may get auto aligned to serve the network.

Further, the disclosed solution does not require any change in any of the network function modules or nodes. In particular, there is no change required in the provisioning architecture of the HSS or the UDM. Subscriber or customer profiles are not duplicated because of the switchover, thereby there is no added complexity.

The method and system of the present disclosure may be implemented in a number of ways. For example, the methods and systems of the present disclosure may be implemented by software, hardware, firmware, or any combination of software, hardware, and firmware. The above-described order for the steps of the method is for illustration only, and the steps of the method of the present disclosure are not limited to the order specifically described above unless specifically stated otherwise. Further, in some embodiments, the present disclosure may also be embodied as programs recorded in a recording medium, the programs including machine-readable instructions for implementing the methods according to the present disclosure. Thus, the present disclosure also covers a recording medium storing a program for executing the method according to the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions, or examples, which are included to enable a person having ordinary skill in the art to make and use the present disclosure when combined with information and knowledge available to the person having ordinary skill in the art.

### ADVANTAGES OF THE INVENTION

The present disclosure provides an efficient approach towards switchover of a user equipment between networks.

The present disclosure does not require any change in the architecture of any network function module or node, and specifically, does not require a change in the provisioning architecture of a home subscriber server (HSS).

The present disclosure avoids duplication of subscriber profiles because of the switchover between networks.

The disclosed solution is applicable to multiple cores of different types, for example, between 4G and 5G cores, and between 5G and 6G cores.

The disclosed solution is applicable to multiple cores of same type, for example, multiple 5G cores identified as core identities. The same is for multiple 4G cores.

We claim:

1. A system (100) for switching at least one user equipment (UE) connected with a first network to a second network on detection of an outage in said first network, said system (100) comprising:
a home subscriber server (HSS) (116) configured to generate a UE-usage-type (UUT) attribute value pair (AVP) value corresponding to said at least one UE; and
a mobility management entity (MME) (120) configured to receive said generated UUT AVP value from said HSS (116) and is further configured to determine a type of said at least one UE based on said received UUT AVP value and switch said at least one UE to said second network based on said determined type of said at least one UE.

2. The system (100) as claimed in claim 1, wherein said determined type is a fourth-generation (4G) UE, a fifth-generation (5G) UE, or a sixth-generation (6G) UE.

3. The system (100) as claimed in claim 1, is configured to detect said outage of the first network based on a number of parameters including a reference signal received power (RSRP), a reference signal received quality (RSRQ), and a signal-to-interference-plus-noise ratio (SINR).

4. The system (100) as claimed in claim 1, wherein the MME is further configured to switch said at least one UE to said first network from said second network upon restoration of said first network.

5. The system (100) as claimed in claim 1, wherein said UUT AVP value further includes an updated location value of said at least one UE.

6. The system (100) as claimed in claim 1, wherein said outage comprises at least one of a hardware outage and software outage of at least one serving cell in said first network.

7. The system (100) as claimed in claim 1, is configured to detect said outage on edge location level, a circle level, and a super core level.

8. The system (100) as claimed in claim 1, wherein said HSS is configured to enable a circle-wise global flag on detection of said outage in a circle level node(s) and sets said UUT AVP value as the second network for the at least one UE latched to said circle level node(s).

9. The system (100) as claimed in claim 8, wherein said circle level node(s) includes a public land mobile network (PLMN).

10. The system (100) as claimed in claim 1, wherein said HSS is configured to disable said circle-wise global flag on resolving said outage in said circle level node(s), thereby enabling transfer of said at least one UE to said circle level node(s).

11. The system (100) as claimed in claim 1, wherein said HSS is configured to enable a global flag on detection of said outage in a super core level node(s) and sets said UUT AVP value as said second network for the at least one UE latched to said super core level node(s).

12. The system (100) as claimed in claim 11, wherein said super core level node(s) includes at least one data center.

13. The system (100) as claimed in claim 11, wherein said HSS is configured to disable said global flag on resolving said outage in said super core level node(s), thereby enabling transfer of said at least one UE to said super core level node(s).

14. The system (100) as claimed in claim 1, wherein said MME is configured to map said UUT AVP value with a set of predefined UUT values stored in a table corresponding to a number of gateway planes connected with said first network and said second network.

15. The system (100) as claimed in claim 1, wherein said MME is configured to select at least one of a gateway-control plane (GW-C), a fully qualified domain name (FQDN), and a gateway-user plane (GW-U) connected with said second network if said UUT AVP value is corresponds to NO and mapped with at least one UUT values from said set of predefined UUT values stored in said table.

16. The system (100) as claimed in claim 1, wherein said MME is configured to select at least one of a gateway-control plane (GW-C) and a session management function (SMF) connected with said first network if said UUT AVP value is corresponds to 5G and mapped with at least one UUT values from said set of UUT values stored in said table.

17. The system (100) as claimed in claim 1, wherein said MME is configured to select a session management function (SMF) or a user plane function (UPF) if said determined type of said at least one UE is migrated to the 4G/5G.

18. The system (100) as claimed in claim 1, wherein said MME is further configured to switch said at least one UE to said first network from said second network upon restoration of said first network.

19. A method of switching at least one user equipment (UE) connected with a first network to a second network on detection of an outage in said first network, said method comprising:
generating a UE-usage-type (UUT) attribute value pair (AVP) value corresponding to said at least one UE;
determining a type of said at least one UE based on said received UUT AVP value; and
switching said at least one UE from said first network to said second network based on said determined type of said at least one UE.

20. The method as claimed in claim 19, wherein said at least one UE is switched from said second network to said first network on detection an outage in said first network.

21. The method as claimed in claim 19, further comprising switching said at least one UE to said first network from said second network upon restoration of said first network.

22. The method as claimed in claim 21, further comprising detecting said outage of the first network based on a number of parameters including a reference signal received power (RSRP), a reference signal received quality (RSRQ), and a signal-to-interference-plus-noise ratio (SINR).

23. The method as claimed in claim 19, further comprising detecting said outage on edge location level, a circle level, and a super core level.

24. The method as claimed in claim 19, further comprising enabling a circle-wise global flag on detection of said outage in a circle level node(s) and sets said UUT AVP value as the second network for the at least one UE latched to said circle level node(s).

25. The method as claimed in claim 19, further comprising disabling said circle-wise global flag on resolving said outage in said circle level node(s), thereby enabling transfer of said at least one UE to said circle level node(s).

26. The method as claimed in claim 19, further comprising to enabling a global flag on detection of said outage in a super core level node(s) and setting said UUT AVP value as said second network for the at least one UE latched to said super core level node(s).

27. The method as claimed in claim 19, further comprising disabling said global flag on resolving said outage in said super core level node(s), thereby enabling transfer of said at least one UE to said super core level node(s).

28. The method as claimed in claim 19, further comprising mapping said UUT AVP value with a set of UUT values stored in a table corresponding to a number of gateway planes connected with said first network and said second network.

29. The method as claimed in claim 19, further comprising selecting at least one of a gateway-control plane (GW-C), a fully qualified domain name (FQDN), and a gateway-user plane (GW-U) connected with said second network if said UUT AVP value is corresponds to NO and mapped with at least one UUT values from said set of predefined UUT values stored in said table.

30. The method as claimed in claim 19, further comprising selecting at least one of a gateway-control plane (GW-C) and a session management function (SMF) connected with said first network if said UUT AVP value is corresponds to 5G and mapped with at least one UUT values from said set of predefined UUT values stored in said table.

31. A user equipment (UE) configured to switch from a first network to a second network on detection of an outage in said first network, said user equipment comprising:
a processor; and
a computer readable storage medium storing programming for execution by said processor, the programming including instructions to:
generate a UE-usage-type (UUT) attribute value pair (AVP) value corresponding to said UE;
determine a type of said UE based on said generated UUT AVP value; and
switch said UE from said first network to said second network based on said determined type of said UE.

32. A computer program product comprising a non-transitory computer-readable medium comprising instructions that, when executed by one or more processors, cause the one or more processors to perform:
generate a UE-usage-type (UUT) attribute value pair (AVP) value corresponding to at least one user equipment (UE);
determine a type of said at least one UE based on said received UUT AVP value; and
switch said at least one UE from said first network to said second network based on said determined type of said at least one UE.
